(19) United States
(12) Patent Application Publication
(10) Pub. No.: US 2012/0263541 A1
(43) Pub. Date: Oct. 18, 2012

(54) SUBSEA STRUCTURE FOR PIPE ASSEMBLIES

(76) Inventors: Per Lillejordet, Bjornemyr (NO); Philip Namork, Stabekk (NO); Ulf Lonnemo, Rasta (NO); Jorund Engeland Torjussen, Oslo (NO); Terje Pedersen, Nesoya (NO); Ronny Haldorsen, Oslo (NO)

(21) Appl. No.: 13/087,552

(22) Filed: Apr. 15, 2011

(51) Int. Cl. F16L 1/12; F16L 57/00; F16L 1/06

(52) U.S. Cl. 405/170; 405/184.4; 405/184.1

(57) ABSTRACT

A subsea structure for supporting pipes/pipe assemblies (2′) that are connected to subsea installations. The structure has a generally horizontal support member (5) for supporting said pipes/pipe assemblies. The horizontal support member is movably engaged with a generally vertical supporting member (2) at one or both ends thereof the vertical support member is anchored to a base member (3). In the vertical support member (2) a lifting mechanism with intermeshing ratchet dogs (32, 33) and elongate ratchets (12) is arranged, which is operated by a vertical screw (13).

### FIELD OF THE INVENTION

The present invention in general relates to a subsea structure for pipes/pipe assemblies.

In particular, the present invention relates to a novel structure per se for its application subsea, for achieving controlled elevation and support above the seabed of substantially horizontal pipes and pipe assemblies. The structure according to the present invention, achieves excellent and effective management of loads, moments and torques involved in different phases of installation of subsea pipelines and subsequent life cycle load alternations.

More particularly, the present invention relates to a subsea structure for pipes/pipe assemblies according to the preamble of claims 1, 18 and 21.

### TECHNICAL BACKGROUND OF THE INVENTION

Installation of pipes/pipe assemblies (hereinafter often referred to as pipe lines as a synonymous terminology) in a subsea environment, primarily for hydrocarbon production, has been a challenge over the years. These pipe lines, as it is known, have to be connected to various subsea equipments, in a subsea production/exploration environment. Furthermore, laying/installation and maintenance of pipe lines in a subsea environment at various stages, encounters loads, moments and torques of varying degrees.

The need for going into the deeper waters for undertaking hydrocarbon exploration and production has resulted in modernization of subsea equipments for that purpose. With the advent of more and more modern equipments in a subsea production/exploration system, involvement of loads, moments and torques of varying degrees at different phases of installation of subsea pipelines, have intensified. So, perfect and effective management of such loads, moments and torques is now of immense importance.

Hence, permanently relieving the attachments of the pipe lines and ensuring perfect inclination/positioning of such pipe lines before connection with one or more subsea equipments are two aspects, which are of prime importance under the present scenario. Also, pipe lines of varying dimensions and designs are now involved in subsea production and exploration system. Further, the need for corrections/adjustments and replacements in pipe lines during the course of prolonged operation, is also very important these days with the advancement in deep sea hydrocarbon production/exploration technology.

Having regard to the above, the traditional technologies in this field like rock dumping and sand bagging to support pipes have become obsolete, as they are too time consuming and need specialized vessels to be mobilized. Further, the need for corrections and adjustments and replacements in pipe lines during the course of prolonged operation, has further aggravated their lack of suitability.

The needs as stated in the preceding paragraphs hereinabove, has marked the necessity for designing improved subsea supporting structures for pipe lines, so that all such needs are taken care of. However, significant developments in that view of the matter are yet to be achieved. Furthermore, patents/patent publications addressing the specific issues as narrated in the preceding paragraphs, are not known to the best of the knowledge of the applicants.

Accordingly, there is a long felt need for a subsea supporting structure for pipes/pipe assemblies, for achieving controlled elevation and support above the seabed of substantially horizontal pipes and pipe assemblies.

There is also a need for such structure which achieves excellent and effective management of loads, moments/torques involved in different phases of installation of subsea pipelines.

Furthermore, there is also a need for a structure which facilitates, corrections/adjustments and replacements in pipe lines during the course of prolonged operation during hydrocarbon exploration/production in a subsea environment.

The present invention meets the above long felt needs and other associated needs as discussed hereinbefore and hereinafter.

The present invention was partially disclosed in SPE News June 2010 edition, which is less than one year prior to the filing of the present application.

### OBJECTS OF THE INVENTION

The primary object of the present invention is to provide a reliable subsea structure for pipes/pipe assemblies for achieving controlled elevation and support above seabed, of substantially horizontal pipes and pipe assemblies.

It is yet another object of the present invention to provide a subsea structure for pipes/pipe assemblies which achieves, excellent and effective management of loads, moments and torques involved in different phases of installation and maintenance of subsea pipelines.

It is another object of the present invention to provide a subsea structure for pipes/pipe assemblies which facilitate permanently relieving the attachments of the pipe lines and ensuring perfect inclination/positioning of such pipe lines before connection with one or more subsea equipments.

It is a further object of the present invention to provide a subsea structure for pipes/pipe assemblies which facilitate corrections/adjustments and replacements of pipe lines during the course of prolonged operation.

It is another object of the present invention to provide a subsea structure for pipes/pipe assemblies which facilitate reduction in installation time and cost.

It is yet another object of the present invention to provide a subsea structure for pipes/pipe assemblies which facilitate easy access to the pipe lines and adjustments during installation, tie-in operations.

It is a further object of the present invention to provide a subsea structure for pipes/pipe lines which can be pre installed and/or post installed.

All through the specification including the claims, the words “pipes/pipe assemblies/pipe lines”, “lift boom”, “guides”, “bearings”, “vertical posts”, “cantilever”, “lift screw”, “Pipe Stop”, are to be interpreted in the broadest sense of the respective terms and includes all similar items in the field known by other terms, as may be clear to persons skilled in the art. Restriction/limitation, if any, referred to in the specification, is solely by way of example and used to facilitate the understanding of the present invention. When the terms “horizontal” and “vertical” are used, this means “generally horizontal” resp. “generally vertical”, as minor deviations from the exact horizontal resp. vertical are not detrimental to the function of the devices, and can thus be accepted.

### SUMMARY OF THE INVENTION

According to a first aspect of the present invention there is provided a subsea structure for pipes/pipe assemblies, said pipes/pipe assemblies being adapted to be connected to one or more sub-sea equipments. According to the invention the structure has a generally horizontal support member for receiving said pipes/pipe assemblies. This horizontal support member is movably engaged with vertical supporting member(s) at one or both ends thereof. The vertical supporting member(s) is(are) fixed or detachably anchored to a base member.

According to a second aspect of the present invention there is provided a subsea structure for pipes/pipe assemblies, said pipes/pipe assemblies being adapted to be connected to one or more sub-sea equipments. According to the invention the structure has a generally horizontal support member for receiving said pipes/pipe assemblies. This is movably engaged with two vertical supporting members at either of its ends such that said vertical supporting members are adapted to elevate and lower said horizontal supporting member. The vertical supporting members are fixed or detachably anchored to a base member.

Preferably, the horizontal support member comprises at least a horizontal beam in the form of a lift boom with a low friction surface or one or more horizontal rolls thereon.

More preferably, the horizontal rolls are suitably coated for preventing damage of said pipes/pipe assemblies.

According to a third aspect of the present invention there is provided a subsea structure for pipes/pipe assemblies, said pipes/pipe assemblies being adapted to be connected to one or more sub-sea equipment. According to the invention the structure has a horizontal support member for receiving said pipes/pipe assemblies. This is movably engaged with a single vertical supporting member at one of its ends such that said vertical supporting member is adapted to elevate and lower said horizontal supporting member. The vertical supporting member is fixed or detachably anchored to a base member.

Preferably, the horizontal support member is a horizontal beam resting on a cantilever along its full length, said cantilever further having a lower horizontal main beam to form a comprehensive lift boom.

More preferably, the horizontal beam is suitably coated for preventing damage of said pipes/pipe assemblies.

### BRIEF DESCRIPTION OF THE DRAWINGS

Having described the main features of the invention above, a more detailed and non-limiting description of two exemplary embodiments will be given in the following with reference to the drawings, in which:

FIG. 1 is an isometric view of one preferred embodiment of the subsea structure according to the present invention, showing all components,

FIG. 2 is an isometric view of the embodiment shown in FIG. 1 with some of the components removed,

FIG. 3a is an isometric view of a lifting assembly for the lift boom,

FIG. 3b is an isometric view of the lifting assembly in FIG. 3a viewed from the opposite side,

FIG. 3c is an isometric view of the lifting assembly including a lift screw,

FIG. 3c is a detailed view of the lifting assembly in place within a vertical guide,

FIG. 4a is an isometric view of the lifting boom,

FIG. 4b is an isometric view of a mechanism for displacing a pipe stop,

FIG. 5 illustrates two of the subsea structures shown in FIG. 1 supporting a pipe in a subsea environment,

FIG. 6 illustrates an isometric view of a second embodiment of the subsea structure according to the present invention supporting a pipe, at an elevated position.

FIG. 7 illustrates a back view of the embodiment illustrated in FIG. 6.

FIG. 8 illustrates a side view of the embodiment illustrated in FIG. 6 showing some additional components.

FIG. 9 illustrates another isometric view of the second embodiment of the subsea structure according to the present invention, supporting a pipe at a lowered position.

FIG. 10 illustrates two of the subsea structures shown in FIG. 6 supporting a pipe in a subsea environment.

### DETAILED DESCRIPTION OF THE INVENTION

The following describes two preferred embodiments of the invention which are exemplary for the sake of understanding the present invention and non-limiting.

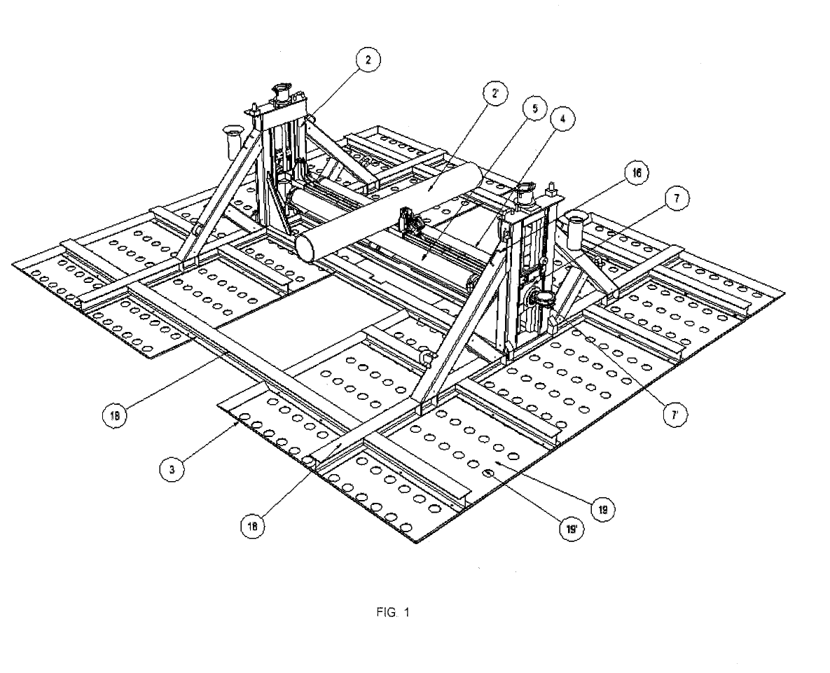

FIG. 1 illustrates a perspective view of the first embodiment of the subsea supporting structure for pipes/pipe assemblies, according to the present invention.

It is a permanent unit for subsea application to achieve a controlled elevation and support above the seabed of substantially horizontal pipes and pipe assemblies. This is to permanently relieve the attachments of the pipes and to achieve a desired inclination of the pipe, as well as to position the pipe before a connection of the pipe to subsea equipment is made. This structure also functions to position the pipe sideways.

The structure is applicable for all types of stiff pipes in a variety of dimensions, and also for several pipes at the same time. Typical non-limiting diameters are from 10 to 50 inches. The vertical load may be say for example, in the order of 100 to 1000 kN.

For deployment, installation and operation of the structure, a surface vessel with dynamic positioning system and a crane heave compensation system is used. The elevation of the structure can be adjusted at any time to adjust for settling of the ground or other dislocations.

Advantageously, the unit consists of equipment which constitutes an independent component of the total connected pipe system. Equipment which is used in connection with installation and operation are tools that are not a part of the completed connected system. Tools that are mechanically or hydraulically activated which are used to initiate the elevation or lowering of the pipe, are operated remotely from a remotely operated vehicle (ROV).

The unit is preferably made from carbon steel and is surface treated with paint and protected against corrosion by the use of galvanic anodes. The unit is designed to be used during the whole life span of the pipeline system that it forms a part of.

As will be understood to persons skilled in the art the forces to which the subsea structure is exposed to are the weight of the pipe, horizontal roll and frictional loads because of movement of the pipe in relation to the support and any unwanted sideways biasing of the pipe.

Now will be described how the subsea structure according to the present invention works to achieve its objectives, with reference to the accompanying FIGS. 1 to 5.

As shown in FIG. 1, the three basic units involved in the structure are a foundation unit 3, two vertical guide posts 2 and a generally horizontal boom 4. The structure can also function effectively to achieve its objectives with one vertical guide post 2, as explained later.

The foundation unit 3 is made of steel girders 18 and plates 19. The plates have perforations 19′ along its surface to reduce resistance during lowering through the water. Galvanic anodes (not shown) are attached to the foundation for providing anti-corrosive protection. The foundation is adapted to sea bed conditions with regard to area and shape. For loose sea bed conditions, the foundation may be equipped with skirts (not shown) at its underside.

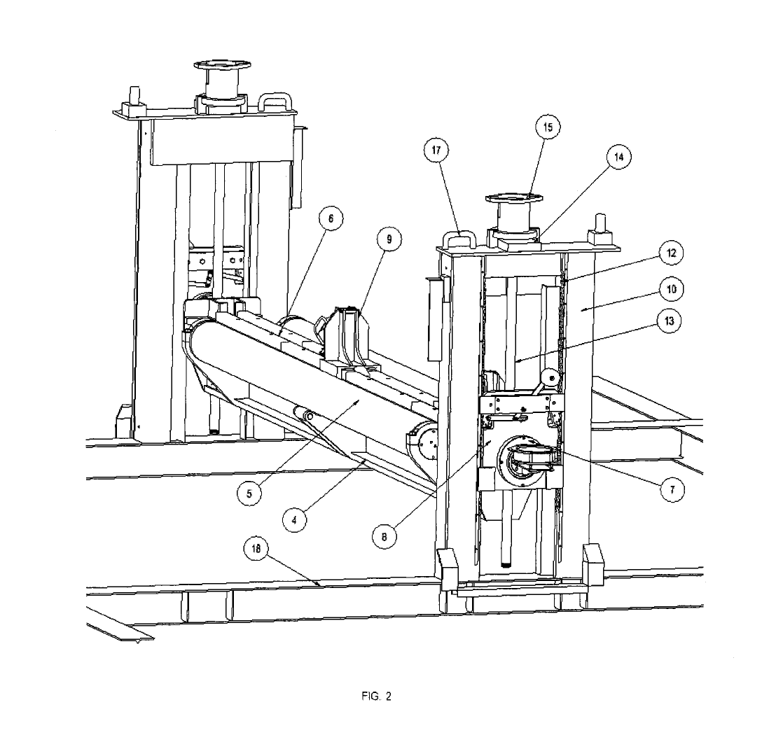

FIG. 2 shows the structure in more detail. The two vertical guide posts 2 are mounted fixed or detachably on the foundation 3 along the support frame 18 on the plate 19. The horizontal support for the pipe is provided by the lift boom 4 having a low friction coating or one or more horizontal rolls 5 thereon. The horizontal rolls 5 if present constitute an integral part of the lift boom 4.

The rolls 5 form the horizontal support for the pipe/pipe assembly 2′. They reduce the horizontal force transferred from the pipe to the supporting structure. Such horizontal forces are mainly caused by thermal expansion and contraction or by subsea currents.

The rolls 5 may be covered with a material that does not damage the surface of the pipe 2′ being supported. The two vertical guide posts 2 are located at either end of the lift boom as shown in FIG. 1.

The lift boom 4 is at each end connected to a hang off plate with a bolted interface, which will be further described below.

The lift boom 4 is elevated and lowered vertically by vertically operated screws 13 at each end.

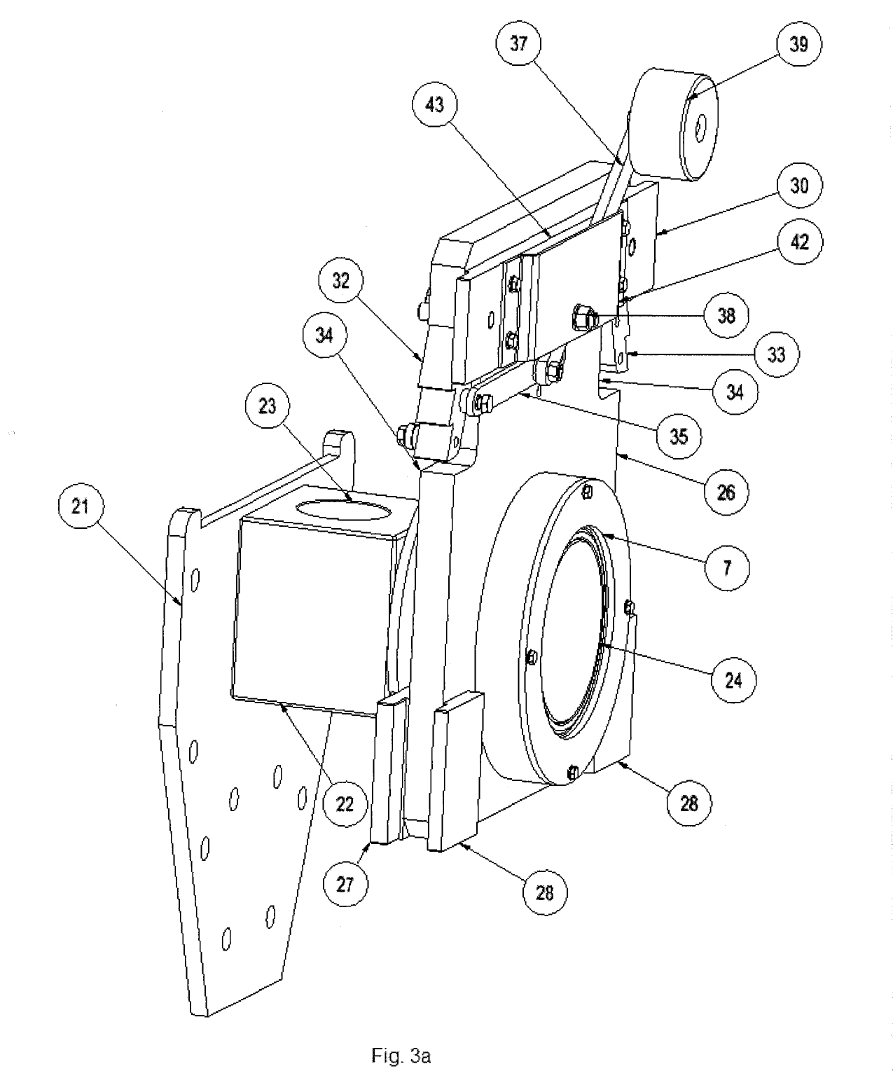

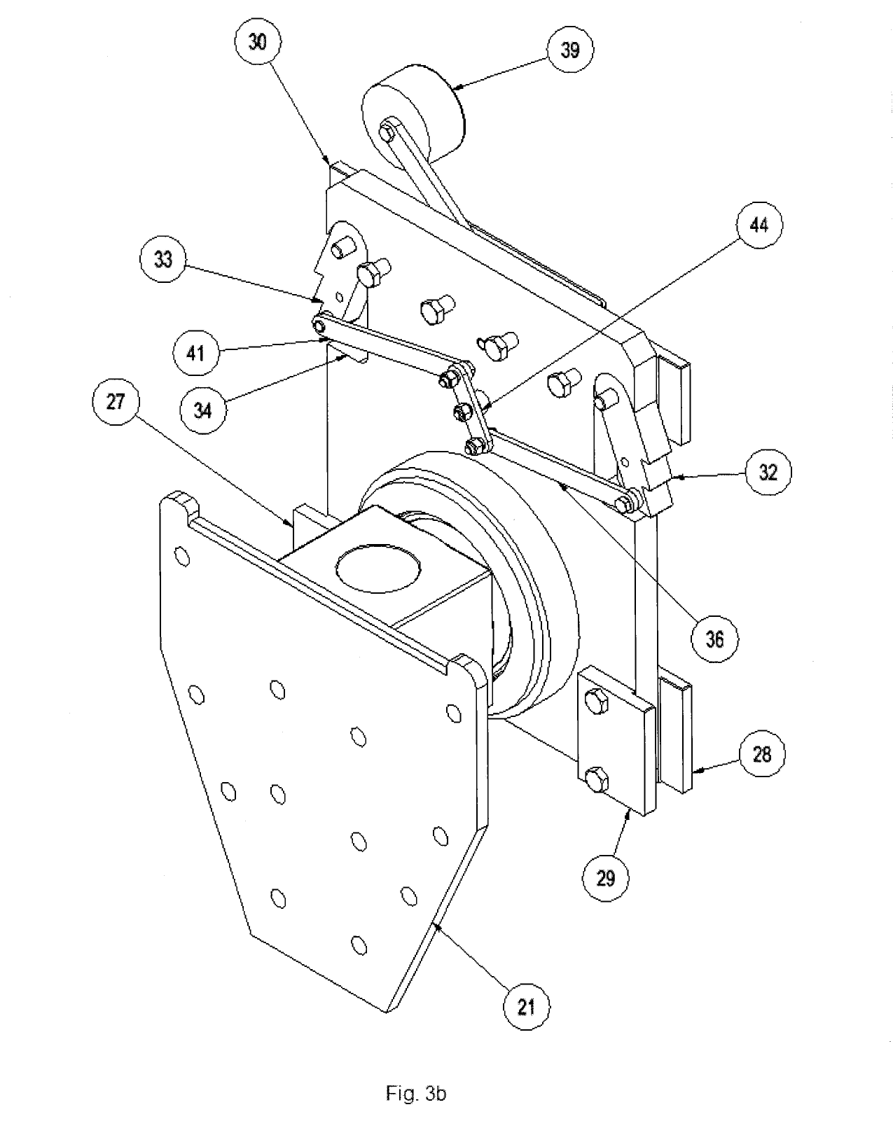

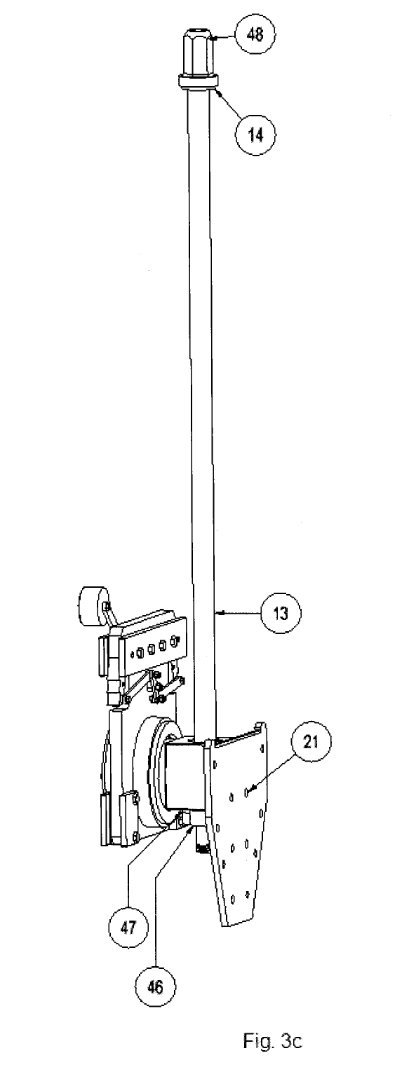

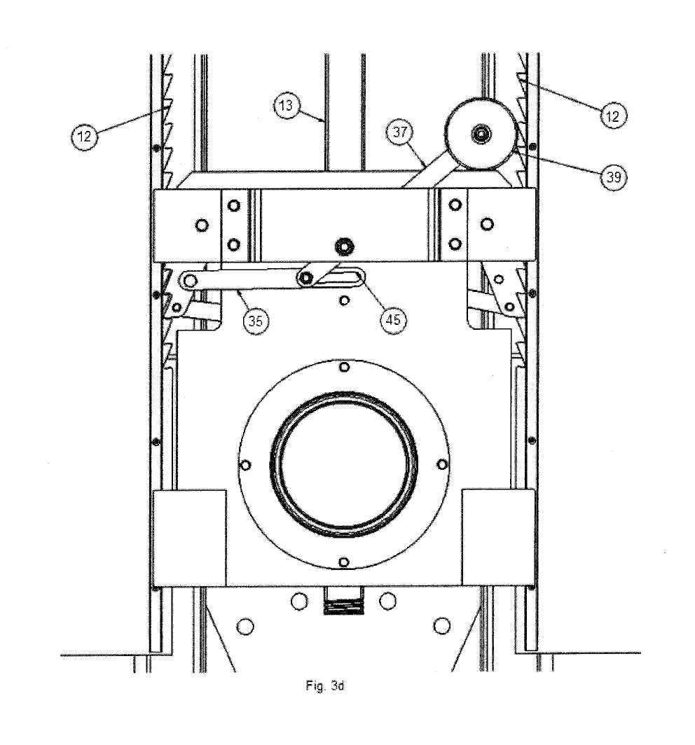

Now, the lifting mechanism for lifting the lift boom 4 and adjustments of the position of the pipes will be further explained with reference to FIGS. 3a-d.

The lift boom 4 is at each end connected to a hang off plate 21 with a bolted interface. The hang off plate fixedly connected to a lifting block 22 having a through bore 23. The lifting block is in turn fixedly connected to a bearing rod 24, which is supported by a circular spherical bearing 7. The bearing 7 is supported in a lifting plate 26. The lifting plate 26 has two pairs of lower guide plates 27, 28 (see also FIG. 3b), one of which is detachable, and upper guide plates 29, 30 (see also FIG. 3b), one of which is detachable. The function of the guide plates 27, 28 will be explained below.

The lifting plate 26 is also equipped with a ratchet dog mechanism 31, which will now be explained referring to FIGS. 3a and 3b. Two ratchet dogs 32, 33 are hingedly attached to the lifting plate 26, one on each lateral edge of the lifting plate 26. The ratchet dogs 32, 32 are situated in notches 34 in the lifting plate 26, so that when the dogs 32, 33 are retracted, the do not extend beyond the perimeter of the lifting plate 26. One of the ratchet dogs 32 is articulatingly connected to an outer link 35 and a first inner link 36. The outer link 35 is at the opposite end of the ratchet dog 32 articulatingly connected to a lower end of a lever 37. The lever 37 is rotatable about a first shaft journal 38. At the second end of the lever is a weight 39.

The inner link 36 is at the opposite end of the ratchet dog 32 connected to a first end of a rotating arm 40, which is midway along the arm fixedly attached to a second shaft journal 44. At the second end of the rotating arm 40 a second inner arm 41 is connected. The second inner arm is at the opposite end connected to the other ratchet dog 33.

The movement of the lever 37 is limited by a bracket 42, which forms a pocket 43 within which the lever 37 can move. As shown in FIG. 3d, the end of the outer link 35 to which the lever 37 is connected, has an elongate hole 45.

When the lever 37 is in the position shown in FIGS. 3a-d, the ratchet dogs 32, 33 are pushed outward. Due to the weight 39 it takes a certain force to push the dogs 32, 33 inward.

When the lever 37 is shifted to a position were it is situated in the other end of the pocket 43, the lever will first move along the length of the elongate hole 45 in the outer link 35 and then pull on the outer link 35 which in turn retracts the dog 32. The dog 32 will push on the first inner link 36, which in turn will rotate the arm 40. The arm 40 will pull on the second inner link 41, which in turn will retract the other dog 33. Due to the weight 39 the lever 37 will stay in this position until the lever is manually moved, e.g., by the use of an ROV, back again to the position shown in FIGS. 3a-d.

FIG. 3d shows the ratchet dog mechanism 31 mounted in the guide post 2. In both lateral walls of each vertical guide post 2 are two elongate ratchets 12. The ratchets 12 are gripped between the guide plates 27, 28, 29, 30, so that the lift plate is capable of sliding along the elongate ratchets 12 and the guide posts 2.

The lift boom 4 is elevated and lowered vertically by vertically operated screws 13 at each end. As best shown in FIG. 3c, each screw 13 is fitted with a nut 46 and a spherical disc 47, which the lifting block 22 is resting on. The nut is prevented from rotating relative to the lifting block 22 by suitable means (not shown). At the upper end of the screw 13 is another nut 48, which is fixed to the screw 13. The nut 48 can be gripped by a torque tool on an ROV. The nut 48 and hence the screw 13 rests on a spherical bearing 14, which in turn rests on a cross beam on top of the vertical guide post 2.

The lift boom 4 is a simply supported unit. The lift boom 4 is adapted to be inclined both in the transverse direction and in the elongate direction as may be required by virtue of the spherical bearing 7 and the spherical bearings 14, 47.

The FIG. 2 also shows the vertical beam main beam 10 of each vertical guide 2. The ratchets 12 and the ratchet dogs 32, 33 form an intermeshing. When a desired position of the lift boom 4 having the pipe/pipe assembly thereon is intended, the lift screws 13 are operated. The ratchet dogs can be set in two modes; “open” and “closed”, as described above. In open mode the ratchet dogs 32, 33 are retracted and the lift boom 4 is free to be adjusted both upwards and downwards. In closed mode the clump weight will transfer a force through the linkage formed by the lever 37, the links 35, 36, 41 and the arm 40 and engage the ratchet dogs 32, 33. As the lifting mechanism is moved upwards the ratchet dogs will engage corresponding ratchet teeth automatically. When the target elevation is reached the screw is reversed and the ratchet and ratchet dogs will intermesh completely transferring all tension from the screw to the ratchet.

At the top portion of each vertical guide there is a receptacle 15 for a torque tool (not shown) for operating the lifting screw 13 by an ROV. There are also on each vertical guide 2, lifting handles 17 that the ROV can grip to stabilize itself during operations.

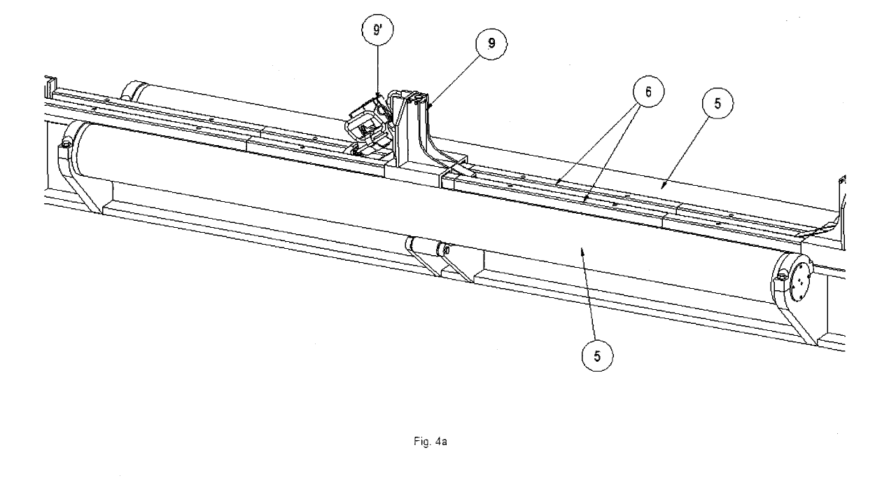

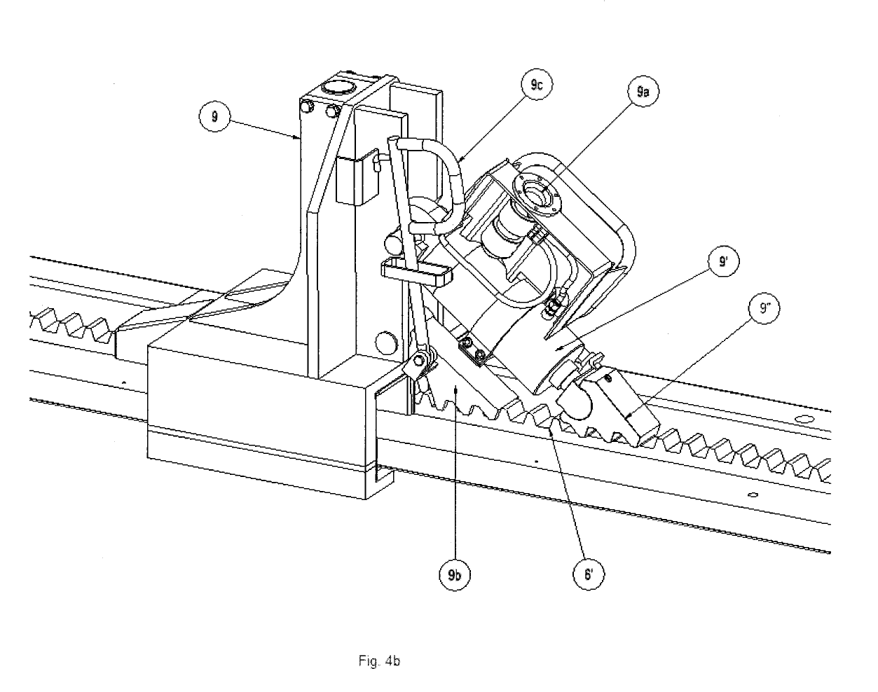

Sidewise movement of the pipe is done by adjustable pipe stops 9. The functioning of this feature is now explained with reference to FIGS. 4a and 4b, where like reference numerals, represent like features.

As shown in FIG. 4a a pipe stop 9 is placed on a rail arrangement 6 on the lift boom 4, between the horizontal rolls 5. The pipe stop 9 is displaced by a retrievable horizontal cylinder 9′. As shown in FIG. 4b, one end of the cylinder 9′ is hinged on the stop 9, while at the other end there is a shoe 9″.

As the hydraulic cylinder 9′ is activated, the shoe 9″ is pushed out and it engages with a rack arrangement 6′ between the horizontal rolls 5 on the lift boom. The cylinder 9′ function is to push the pipe stop 9 sideways, the locking of the pipe stop 9 is performed by a ratchet mechanism with a similar function to the one in the vertical towers. The cylinder 9′ is done hydraulically by connecting an ROV stab in a hydraulic receptacle 9a. Preferably, the pipe stop 9 is equipped with vertical rolls (not shown) to minimize the horizontal forces from the pipe into the supporting structure during adjustment or thermal expansion. The pipe stop can be moved in the opposite direction by lifting the cylinder 9′ and the shoe 9″ to disengage the shoe 9″ from the ratchet 6′. An additional lock mechanism 9b may be present. The lock mechanism 9b is actuated by a lever 9c.

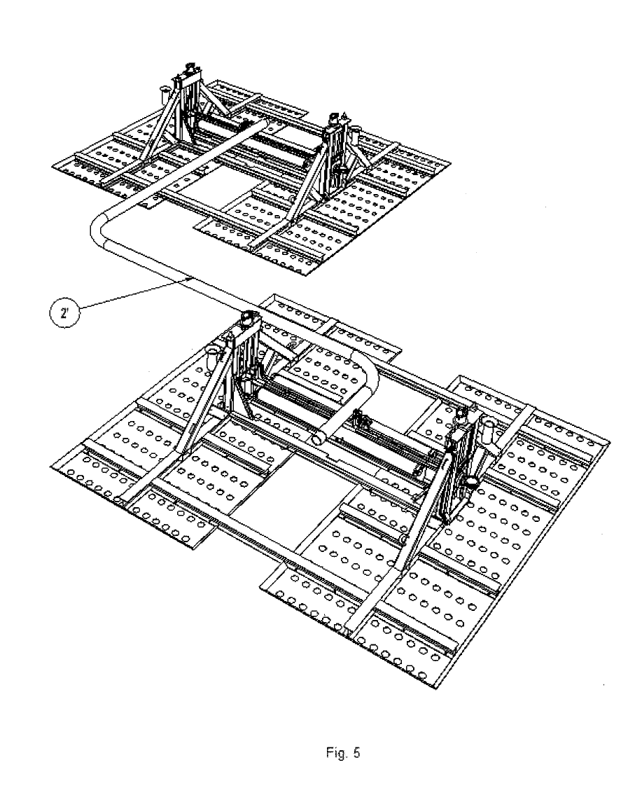

FIG. 5 illustrates two subsea structures shown in FIG. 1 supporting a pipe in a subsea environment. This figure illustrates how a subsea supporting structure according to the present invention functions to effectively support pipes/pipe assemblies in a subsea environment.

From the description of the FIGS. 1 to 5 as provided hereinabove, it will be clear to persons skilled in the art that the subsea structure according to the present invention has the following non-limiting advantages:
1. Work as a permanent support for subsea pipes.
2. The elevation of the pipe can be adjusted at any time.
3. The sideways position of the pipe can be adjusted at any time.
4. The pipe can slide sideways within a predetermined limited range.
5. The pipe can move axially due to thermal expansion/contraction or subsea currents.
6. The lift boom is equipped with a coating that does not damage the surface of the pipe.
7. The lift boom is self adjusting according to the axial inclination of the pipe to distribute the load evenly between the rolls.
8. Lifting points placed at elevated positions of the structure secure stable positioning during installation.
9. Vertical loads from the pipe are taken through the lift boom, into the guide housings, down through the vertical main beams and out to the foundation.
10. Operation of the screw and, with this, adjustment of the lifting height is accomplished by a remotely operated vehicle.
11. The lifting screw is only exposed to tension during the operation. All torques and sideways moments are taken up by the lift boom and guides.
12. The lift screw is relieved by locking ratchet dogs for permanent load transfer after final positioning of the pipe and the overall time and cost of installation is low.
13. The lifting boom can be set to different heights on the two sides in order to correct for transverse sloping seabed and consequently stabilize the pipe from moving in a transverse direction.

The structure is placed in a predetermined position and orientation on the seabed. The pipe is placed so that it is supported by the structure. Correct elevation above the seabed is achieved by operating the lift screws of the structure. Post adjustment over time can be made. The locking ratchet dogs are the permanent load bearing elements.

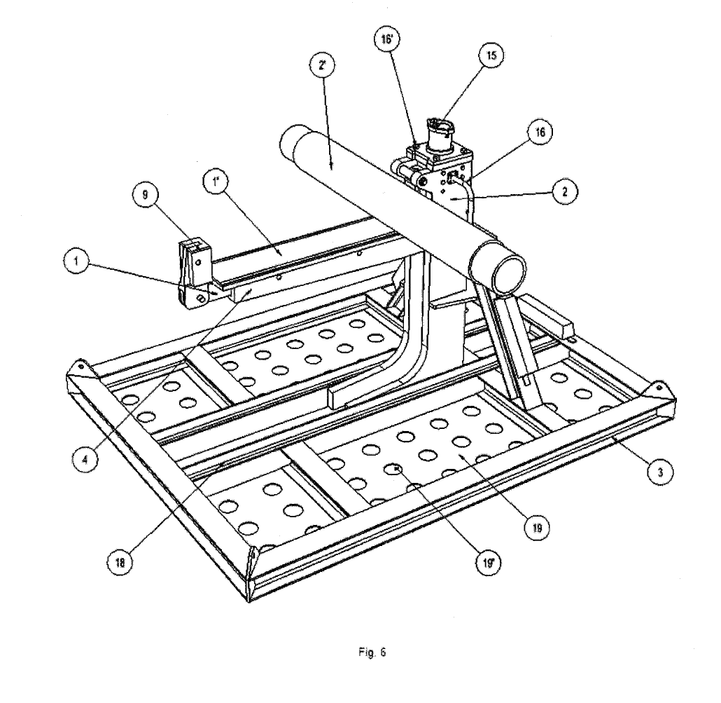

Now the second embodiment of the subsea structure according to the present invention will be described with reference to FIGS. 6 to 10 where the like reference numerals as in FIGS. 1 to 5, indicate similar features, essentially performing the same function.

FIG. 6 illustrates a perspective view of the second embodiment of the subsea supporting structure for pipes/pipe assemblies, according to the present invention.

It is a permanent unit, for its application subsea to achieve a controlled elevation and support above the seabed of substantially horizontal pipes and pipe assemblies. This is to permanently relieve the attachments of the pipes before a connection of the pipe to subsea equipment is made and also ensures proper inclination/positioning. It can be used for all types of stiff or flexible pipes in a variety of dimensions, and also for several pipes at the same time.

For deployment, installation and operation of this subsea structure a surface vessel with dynamic positioning system and a crane heave compensation system is used. It can be installed before or after the pipe is installed. The lowering and installation under an already deployed pipe can be done if the pipe has a basis elevation above the seabed. The elevation of the entire structure can be adjusted at any time to adjust for settling of the ground or other dislocations. The design height of the lift boom in the lowermost position is minimized to facilitate installation under already deployed pipes.

The structure consists of equipment which constitutes an independent component of the total connected pipe system. Equipment which is used in connection with installation and operation are tools that are not a part of the completed connected system. Tools that are mechanically or hydraulically activated, which are used to initiate the elevation or lowering of the pipe, are operated by a remotely operated vehicle (ROV). A standard subsea tool (API torque tool) will preferably, but not limited to, be used for operating the unit.

The unit is typically made from carbon steel and is surface treated with paint and protected against corrosion by the use of galvanic anodes. The unit is designed to be used during the whole life span of the pipeline system that it forms a part of.

The forces the unit is exposed to are the weight of the pipe, horizontal roll and friction loads because of movement of the pipe in relation to the support. Sideways end stops prevent the pipe from moving beyond the allowable area.

In FIG. 6 the basic units of the structure are illustrated. It comprises a horizontal support 1, 1′, 4 for the pipe 2′ , a vertical guide 2 and a foundation member 3 having perforations 19′, plate 19 and frame 18. The foundation member 3 and its components perform the same function as described with reference to FIG. 1 and those are not repeated again for the sake of brevity.

The horizontal support for pipe 2′ comprises a horizontal beam 1′ resting on a cantilever 1 along its full length, the cantilever 1 further having a lower horizontal main beam 4 to form a comprehensive lift boom 1, 1′, 4. Preferably, the horizontal beam 1′ is suitably coated for preventing damage of the pipes/pipe assemblies 2′.

The vertical member is a vertical guide 2 movably engaged at one end of the lift boom 1, 1′, 4, such that it is movable upwardly and downwardly. Contrary to the first embodiment, there is a single vertical guide at one end of the lift boom. Further, contrary to the first embodiment, where the lift boom is simply supported, this lift boom is cantilever type. These are the two fundamental differences between the two embodiments and both fall within the scope of the invention, in as much as the basic construction and manner of functioning are basically the same, as it should be clear from the description hereinbefore and hereinafter.

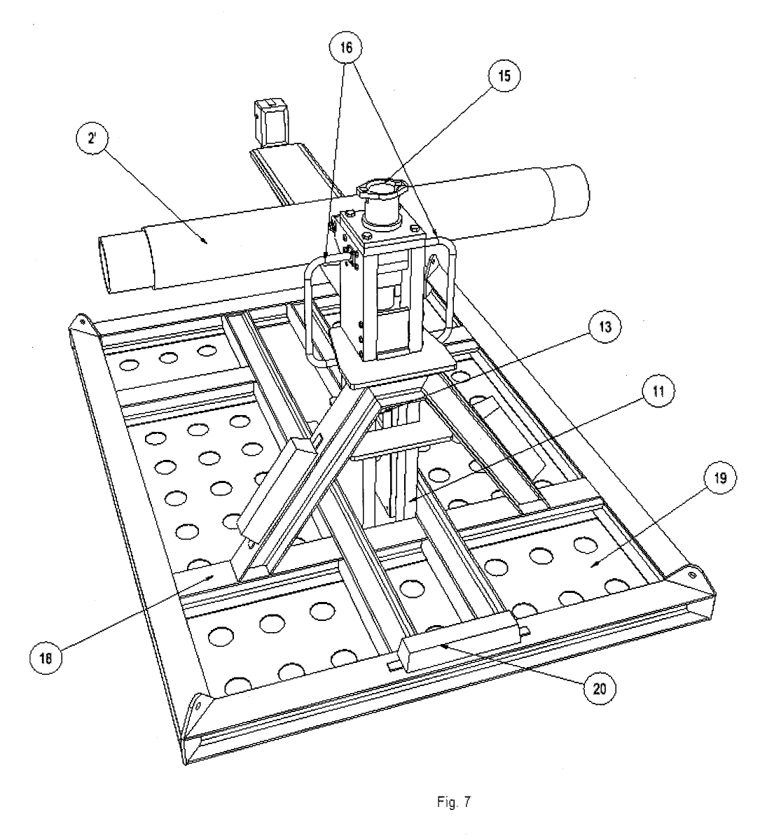

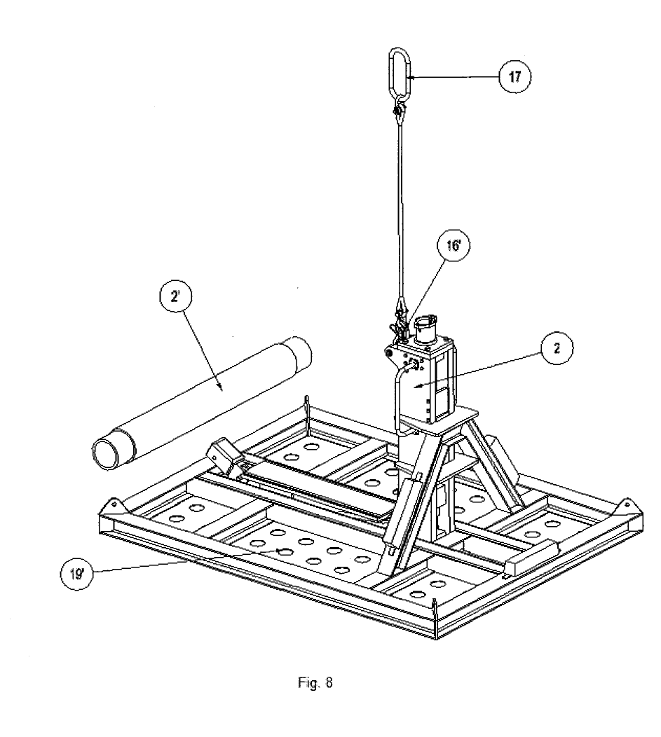

Now, the functioning will be further explained with reference to FIGS. 7 and 8.

The lift boom 4 is elevated and lowered vertically by a vertically operated screw 13 having a nut and a spherical disc bearing (not shown), on the top of the vertical guide 2 for that purpose. The vertical guide 2 has two parallel cheeks 11 at the later walls thereof, detachably attached to the foundation member 3 along the frame 18. This attachment may be a bolted or welded attachment. Galvanic anodes 20 are attached to the foundation member 3 as anti-corrosive units.

The lift screw 13 is equipped with a square shaped threaded nut and a spherical disc bearing (not shown) to self lock the lift boom 1, 1′, 4 having pipes/pipe assemblies 2′ thereon.

The lifting mechanism of this embodiment can alternatively also basically be of the same construction as the lifting mechanism explained above in connection with FIGS. 3a-d.

Advantageously, a pipe stop 9 is provided for lateral adjustment of the pipes/pipe assemblies relative to the lift boom 1, 1′, 4. The pipe stop is hinged in order to minimize the pipe elevation needed to insert the boom underneath the pipeline. The pipe stop 9 may be equipped with a vertical roll (not shown) to minimize horizontal forces generated thereon due to adjustment and/or thermal expansion.

FIG. 7 also shows the receptacle 15 for the lift screw torque tool and the ROV handles 16. FIG. 8 also shows a sling 17 which is attached to the lifting point 16′. All these are integral with the vertical guide 2 at an elevated position.

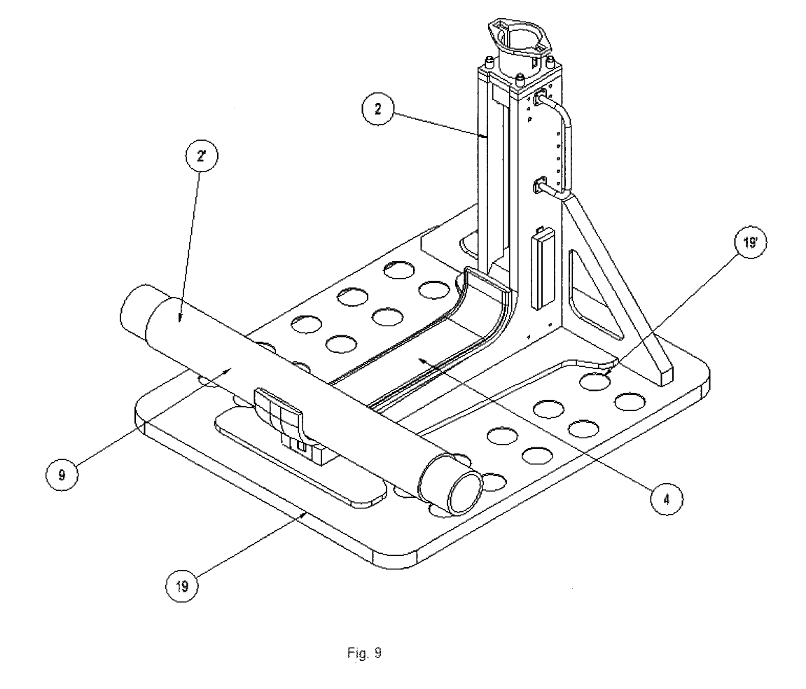

The FIG. 9 shows a position, where the pipe 2′ is in a lowered position, contrary to FIG. 6 where the pipe is at an elevated position.

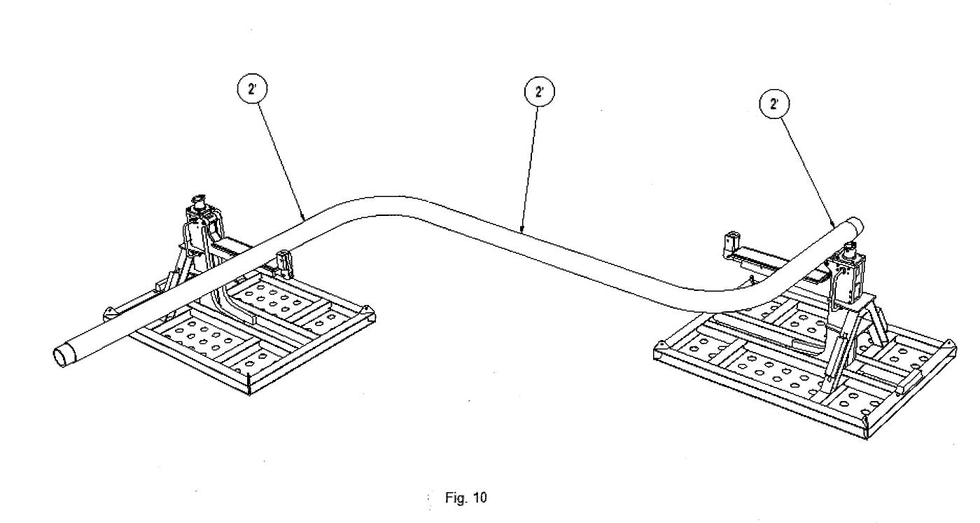

FIG. 10 illustrates two subsea structures shown in FIG. 6 supporting a pipe in a subsea environment. This figure illustrates how a subsea supporting structure according to the present invention functions to effectively support, pipes/pipe assemblies in a subsea environment.

From the description of the FIGS. 6 to 10 as provided hereinabove, it will be clear to persons skilled in the art that subsea structures according to the present invention, have the following non-limiting advantages:
1. Work as a permanent support for subsea pipes.
2. The elevation of the pipe can be adjusted at any time.
3. The pipe can slide sideways within a limited range.
4. The lift boom is equipped with a coating that does not damage the surface of the pipe.
5. The lift boom is self adjusting according to the axial inclination of the pipe.
6. Lifting points placed at elevated positions secure stable lift during installation.
7. Loads from the pipe are taken through the lift boom, into the nut and threaded screw, down through the vertical posts and out to the foundation.
8. Operation of the screw and, with this, adjustment of the lifting height is accomplished by a remotely operated subsea vehicle.
9. The lifting screw is only exposed to tension during the operation. All torques and sideways moments are taken up by the lift boom and guides. The lift screw is self-locking to fix the elevation and overall installation time and cost involved applying the subsea structure, is low.

The installation of the unit can be done by a single lifting line, as shown in FIG. 8. It is placed at a predetermined position and orientation on the seabed.

The structure is placed in a predetermined position and orientation on the seabed. The pipe is placed so that it is supported by the structure. Correct elevation above the seabed is achieved by operating the lift screws of the structure. Post adjustment over time can be made.

The present invention has been described with reference to two preferred embodiments and some drawings for the sake of understanding only and it should be clear to persons skilled in the art that the present invention includes all legitimate modifications within the ambit of what has been described hereinbefore and claimed in the appended claims.

1. A subsea structure for pipes/pipe assemblies, said pipes/pipe assemblies being adapted to be connected to one or more sub-sea equipment, the subsea structure comprising:
a generally horizontal support member for receiving said pipes/pipe assemblies;
wherein said generally horizontal support member is movably engaged with a generally vertical supporting member at one or both ends thereof; and
wherein said generally vertical supporting member is anchored to a base member.

2. The subsea structure according to claim 1, wherein said generally horizontal support member comprises at least one generally horizontal beam in the form of a lift boom with or without one or more generally horizontal rolls thereon.

3. The subsea structure according to claim 2, wherein said at least one of the generally horizontal beam and the generally horizontal rolls has an adjustable elevation above sea bed.

4. The subsea structure according to claim 2, further comprising at least two vertical members at each end of said lift boom in the form of vertical guides having respective housings that accommodate the ends of said lift boom.

5. The subsea structure according to claim 4, wherein said lift boom is at each end supported by bearings in respective housings and are elevated and lowered vertically by vertically operated screws at each end, in respective housings.

6. The subsea structure according to claim 5, wherein in either lateral wall of each said vertical guide, there are provided ratchets and corresponding vertical ratchet dogs and a linkage between the vertical ratchet dogs operated by a lever with a clump weight for securely receiving said lift boom having pipe/pipe assemblies thereon, in an event of releasing of tension by a lifting screw.

7. The subsea structure according to claim 2, wherein said at least one generally horizontal beam is a cantilever supported by the generally vertical supporting member at one end.

8. The subsea structure according to claim 7, wherein said generally vertical member supporting member is a single vertical guide movably engaged at one end of said lift boom, such that said lift boom is movable upwardly and downwardly.

9. The subsea structure according to claim 8, wherein said single vertical guide has two parallel cheeks at the later walls thereof, detachably attached to said base member, said single vertical guide having a bearing for a lift screw to elevate and lower said lift boom.

10. The subsea structure according to claim 9, wherein said lift screw is equipped with a threaded nut to self lock said lift boom.

11. The subsea structure according to claim 2, wherein said subsea structure has at least one pipe stop for lateral adjustment of said pipes/pipe assemblies relative to said lift boom.

12. The subsea structure according to claim 11, wherein said at least one pipe stop is movably located on a rail arrangement on said lift boom.

13. The subsea structure according to claim 12, wherein said at least one pipe stop is moved by a hydraulic cylinder.

14. The subsea structure according to claim 13, wherein one end of said hydraulic cylinder is hinged to the at least one pipe stop, while another end of said hydraulic cylinder is provided with a shoe for engagement with a rack arrangement on said lift boom.

15. The subsea structure according to claim 11, wherein said at least one pipe stop is movably located on said lift boom.

16. The subsea structure according to claim 11, wherein said at least one pipe stop is equipped with a vertical roll to minimize horizontal forces generated thereon due to at least one of adjustment and thermal expansion.

17. The subsea structure according to claim 1, wherein said base member is a foundation for sea bed conditions with regard to area and shape.

18. A subsea structure for pipes/pipe assemblies, said pipes/pipe assemblies being adapted to be connected to one or more sub-sea equipment, the subsea structure comprising:
a generally horizontal support member for receiving said pipes/pipe assemblies;
wherein said generally horizontal support member is movably engaged with two generally vertical supporting members at either of its ends such that said two generally vertical supporting members elevate and lower said generally horizontal supporting member; and,
wherein said two vertical supporting members are anchored to a base member.

19. The subsea structure according to claim 18, wherein said generally horizontal support member comprises at least one horizontal beam in the form of a lift boom with one or more generally horizontal rolls thereon.

20. The subsea structure according to claim 19, wherein said generally horizontal rolls are suitably coated for preventing damage of said pipes/pipe assemblies.

21. A subsea structure for pipes/pipe assemblies, said pipes/pipe assemblies being adapted to be connected to one or more sub-sea equipment, the subsea structure comprising:
a generally horizontal support member for receiving said pipes/pipe assemblies;
wherein said generally horizontal support member is movably engaged with a single generally vertical supporting member at one of its ends such that said single generally vertical supporting member elevates and lowers said generally horizontal supporting member; and
wherein said single generally vertical supporting member is anchored to a base member.

22. The subsea structure according to claim 21, wherein said single generally horizontal support member is a cantilevered horizontal beam.

23. The subsea structure according to claim 22, wherein aid cantilevered horizontal beam is suitably coated for preventing damage of said pipes/pipe assemblies.
